(19) United States
(12) Patent Application Publication
(10) Pub. No.: US 2012/0028089 A1
(43) Pub. Date: Feb. 2, 2012

(54) GAS RELEASE FROM A BATTERY CELL

(76) Inventor: Jyrki Mustakallio, Halikko (FI)

(21) Appl. No.: 13/263,181

(22) PCT Filed: Apr. 30, 2009
(86) PCT No.: PCT/FI09/50341

§ 371 Date: Oct. 6, 2011

(51) Int. Cl. H01M 2/12; H01M 10/04

(52) U.S. Cl. 429/53; 29/623.1; 29/623.2

(57) ABSTRACT

A lithium-ion or polymer-ion battery or generally a battery with electrolyte that is incompatible with water. The battery has a battery cell and a gas-tight casing around the battery cell. A vent is arranged in the casing and configured to allow exit of gases from the battery cell. The vent contains a body with a circumferential wall defining an external surface and a space within the body. The external surface provides a sealing surface configured for hermetic sealing the vent to the casing. The vent further contains a gas separation element for passing through gases from the battery cell and for substantially inhibiting electrolyte of the battery cell from passing through, configured to divide a given portion of the space defined by the circumferential wall into a first chamber and a second chamber. The vent also contains a water separation element within the second chamber, which water separation element further defines the second chamber and substantially prevents entry of water as liquid or humid air through the second chamber to the gas separation element. The vent is configured to enable release of gases from within the battery cell while preventing access of water into the batter cell.

### TECHNICAL FIELD

The present invention generally relates to gas release from a battery cell. The invention relates particularly, though not exclusively, to releasing gas from a battery of a portable device.

### BACKGROUND ART

Batteries are needed for storing chemical energy for subsequent use in different portable devices such as mobile phones. On development of battery technology, the batteries have become more capacious per weight unit, but modern batteries are also very sensitive to water. For instance, Lithium-ion (Li-ion) batteries may burn violently if the interior of the battery contacts with water. Even minute amounts of water may also impair the properties of the battery so that the manufacturing should be carried out in very dry air (such as 1.5% relative humidity).

Li-ion battery manufacture typically involves covering contents of a cell in a casing that has metallic walls. The use of Li-ion batteries relieves some gases, mainly hydrogen and carbon dioxide. Such gas production is more substantial at the start. Hence, the batteries are typically exposed to initial ageing during manufacture. The cells are filled with electrolytes and then charged and exhausted while letting developing gases safely out of the cells before the cells are finally sealed and shipped for use.

### SUMMARY

According to a first example aspect of the invention there is provided an apparatus comprising:
a body with a circumferential wall defining an external surface and a space within the body, the external surface comprising a sealing surface configured for hermetic sealing to a wall of a battery cell;
a gas separation element configured to pass through gases from the battery cell and to substantially inhibit battery of the battery cell from passing through, configured to divide a given portion of the space into a first chamber and a second chamber; and
a water separation element within the second chamber and further defining the second chamber, configured to substantially prevent entry of water as liquid or humid air through the second chamber to the gas separation element.

The gas separation element may comprise a selectively permeable membrane.

The circumferential wall may be circular or of another form.

The selectively permeable membrane may comprise any of the following: porous plastics, porous metals, porous, glasses, porous ceramics, porous semiconductors, and any combination thereof.

The selectively permeable membrane may comprise a porous base layer. The porous base layer may comprise pores of diameter suited to allow release of gases while withholding electrolyte liquid.

The porous base layer may be coated with a further material so as to control pore size distribution. The further material may comprise one or more selectively permeable materials. The selectively permeable materials may be selected from a group consisting of: Pt, Pd, alloys or Pd, Pd/Ag alloy, Pd/Cu alloy, Ti/Ni alloy, ZrMn₂, LaNi₅, La, Ti, Zr, V, Nb, Ta, Cr, Mo, W, Fe, Ru, and Co.

The gas separation element may further comprise a gas bubble trap configured to trap gas bubbles in different orientations of the apparatus.

The gas bubble trap may comprise a set of obliquely aligned trap members.

The circumferential wall may be generally shaped as a cylinder. The gas separator may comprise a layer substantially perpendicular to the circumferential wall. The bubble trap may comprise an annular ring obliquely aligned in proximity of the gas separator such that a narrow corner is formed between an edge of the annular ring and the layer so as to arrest gas bubbles.

The water separation element may comprise a pressure releasable valve member configured to release gases from the second chamber when pressure in the second chamber reaches a predetermined pressure limit.

The pressure releasable valve member may be configured to release gases from the second chamber to outside of the apparatus such that pressure in the second chamber exceeds the pressure behind the pressure release valve member while a gas penetrable opening is provided by the pressure releasable valve member.

The water separation element may comprise a biasing member configured to apply a closing force on the pressure releasable valve member.

The biasing member may be integrally formed by the pressure releasable valve member.

The gas separation element may be configured to inhibit penetration of salts into the gas separation element. The inhibiting may employ osmotic pressure.

The apparatus may comprise a processor and a connector configured to functionally connect the processor to the battery cell; wherein the processor is configured to monitor operation of the battery cell.

The gas separation element may be configured to electrically change permeability properties thereof. The gas separation element may be configured to change permeability properties thereof under control of the processor. The processor may be configured to increase permeability of the gas separation element when the battery cell is particularly likely to release gases.

The sealing surface may be configured such that increasing pressure within the battery cell presses the sealing surface against the wall of the battery cell.

The cell may be exothermically reactive with water.

The battery cell may be a lithium-ion cell. Alternatively, the battery cell may be a polymer-ion cell.

According to a second example aspect of the invention there is provided an apparatus comprising:
a battery cell;
a casing around the battery cell, wherein the casing is gas-tight;
a vent arranged in the casing and configured to allow exit of gases from the battery cell; wherein the vent comprises:
a body with a circumferential wall defining an external surface and a space within the body, the external surface comprising a sealing surface configured for hermetic sealing to the casing;
a gas separation element configured to pass through gases from the battery cell and to substantially inhibit electrolyte of the battery cell from passing through, configured to divide a given portion of the space into a first chamber and a second chamber; and
a water separation element within the second chamber and further defining the second chamber, configured to substantially prevent entry of water as liquid or humid air through the second chamber to the gas separation element.

According to a third example aspect of the invention there is provided a method comprising:
passing gases from a first chamber within a battery cell through a gas separation element to a second chamber while preventing electrolyte of the battery cell from passing through the gas separation element; and
allowing gases exit the second chamber through a water separation element while preventing entry of water as liquid or humid air into the second chamber.

The method may further comprise releasing gases from the second chamber through the water separation element when pressure in the second chamber reaches a predetermined pressure limit.

According to a fourth example aspect of the invention there is provided a method comprising:
mounting an apparatus according to the first example aspect to a casing of a battery cell; and
sealing hermetically the external surface to the casing.

The sealing may be carried out such that developing of pressure within the battery cell tightens the sealing.

According to a fifth example aspect of the invention there is provided an apparatus comprising:
body means with a circumferential wall for defining an external surface and a space within the body, the external surface comprising a sealing surface for hermetic sealing to a wall of a battery cell;
gas separation means configured to pass through gases from the battery cell and to substantially inhibit electrolyte of the battery cell from passing through, configured to divide a given portion of the space into a first chamber and a second chamber; and
a water separation means within the second chamber and further defining the second chamber, configured to substantially prevent entry of water as liquid or humid air through the second chamber to the gas separation means.

According to a sixth example aspect of the invention there is provided an apparatus comprising:
battery cell means;
casing means for being around the battery cell means, wherein the casing means is water-tight;
vent means arranged in the casing and configured to allow exit of gases from the battery cell means; wherein the vent means comprises:
   body means with a circumferential wall defining an external surface and a space within the body means, the external surface comprising a sealing surface for hermetic sealing to the casing;
   gas separation means for passing through gases from the battery cell and for substantially inhibiting electrolyte of the battery cell from passing through, configured to divide a given portion of the space into a first chamber and a second chamber; and
   water separation means within the second chamber and further defining the second chamber, for substantially preventing entry of water as liquid or humid air through the second chamber to the gas separation element.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows an isometric drawing of an example battery cell according to an embodiment of the invention; and

FIG. 2 shows a schematic drawing of the battery cell of FIG. 1, seen from the side;

FIG. 3 shows a schematic drawing of the battery cell of FIG. 1, seen from the top;

FIG. 4 shows a cross-section of an example vent for a battery cell according to an embodiment of the invention;

FIG. 5 shows an example gas separation element of the vent of FIG. 4 according to an embodiment of the invention;

FIG. 6 shows an isometric drawing of an example body of the vent of FIG. 4 according to an embodiment of the invention;

FIG. 7 shows an isometric drawing of a detail of the vent of FIG. 4 according to an embodiment of the invention; and

FIG. 8 shows a schematic drawing of a battery comprising a battery cell according to an embodiment of the invention.

### DETAILED DESCRIPTION

In the following description, like numbers denote like elements.

While the invention has been described below in terms of a multitude of example embodiments, various changes can be made therein without departing from the spirit and scope of the invention, as described in the appended claims.

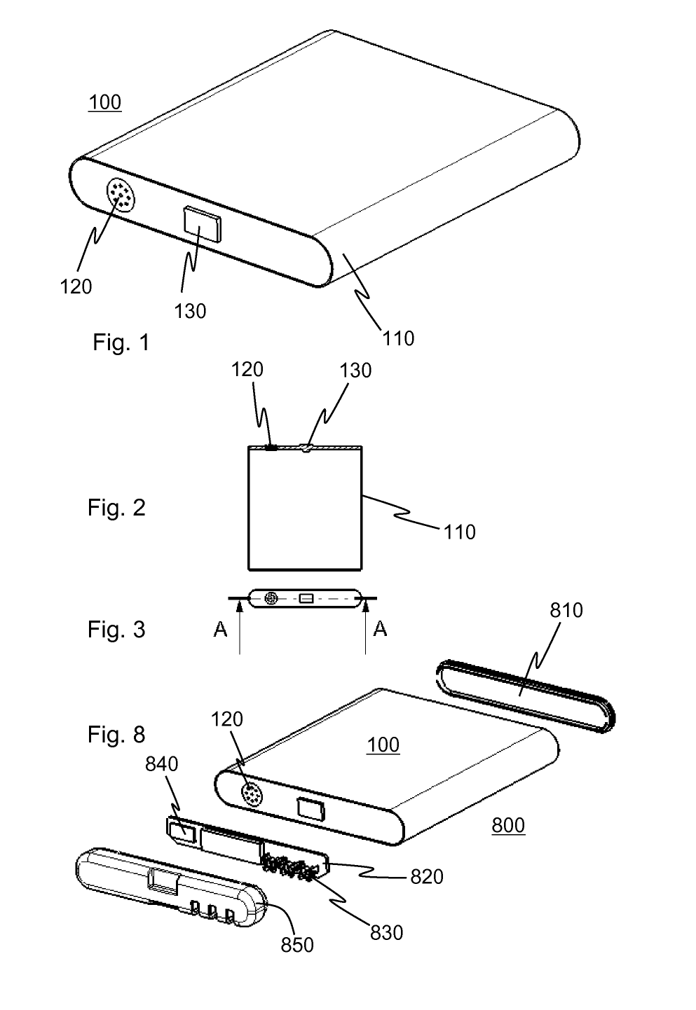

FIG. 1 shows an isometric drawing of an example battery cell 100 according to an embodiment of the invention. The battery cell comprises a casing 110, a vent 120 for releasing battery gases and an accessory 130. The accessory 130 may comprise a connector for connecting the battery cell to a host device such as a portable device like mobile phone. Alternatively, or additionally, the accessory 130 may comprise a processor or chip configured to monitor the use of the battery cell and/or to control the operation of the vent 120. The accessory may be attached to the casing 110.

FIG. 2 shows a schematic drawing of the battery cell of FIG. 1, seen from the side. FIG. 2 suppresses details from within the battery cell 100, but it suffices for understanding the examples described to think that the casing has some parts and wiring and that otherwise the casing 110 is filled with electrolyte that is liquid. The electrolyte is incompatible with water in most of the modern, high-performance rechargeable batteries such as lithium-ion and polymer-ion batteries. Here, it is assumed that the battery cell 100 is using lithium-ion chemistry, while it may be of any other type as well.

The batteries of portable devices are exposed to challenging conditions. Portable devices with their batteries and the batteries as such may be dropped, bent, step upon, and exposed to heat, dirt and moisture, but yet the batteries should maintain their form and capacity. Often, a battery slot within portable devices is tightly dimensioned for the designed dimensions of a battery such that a swollen or otherwise deformed battery may not properly fit in its slot but instead the deformed battery may cause various malfunction in the portable device. It is also appreciated that the battery may be used in any orientation unlike e.g. a car battery that is always kept substantially upright.

It is also appreciated that a modern battery is normally very clean and safe, but under extreme temperatures (e.g. much over 100 degrees of Celsius), or in case of cell internal short circuit for example due to a foreign object damaging the battery cell, or like, the electrolytes may boil and develop excessive pressure in the cell, which may ultimately result in explosion of the cell if no precautions are taken. To avoid such unwanted event, a safety release may be provided e.g. by weakening a particular wall of the battery or by providing a foil cover on the filling opening of the cell such that the cell opens to its surrounding environment before critical amount of excessive pressure is built. It is very rare that such safety release is needed, but when used, the safety release breaks the hermetic casing around the electrolyte and the battery becomes terminally broken and qualifies only for recycling thereafter.

Before the gas development breaks the casing, the mounting pressure may cause permanent protrusion to the casing of the cell. In mobile devices, the cells are dimensioned relatively strong so that they would endure possible bending and compressing as well as dropping by the user. Hence, the cells do withstand a given amount of pressure without loss of original dimensions. However, even after normal use, the batteries may start to visibly swell. The swelling may also increase trough the battery lifetime. A given extent of swelling may be specified to the battery cells as part of product specifications. However, the specified limits may sometimes be exceeded e.g. because of the use of the battery. The swelling may be considered as an aesthetic problem as such, but it may also make the battery poorly fitting to its slot in a portable device and/or interfere with the operation of other components of the portable device by imposing undesired internal forces within the portable device.

In order to avoid such problems, the batteries may be formed relatively round so as to better endure internal pressure, the casings may be made firm by using strong materials and relatively thick walls, and the battery slot may be designed suitably loose particularly around the central region of the battery so as to allow some swelling without harming the operation of the portable device. However, particularly thin portable device cannot accommodate round batteries and also adding any thickness and weight to inhibit swelling is undesirable. Moreover, the producing of gases in the cell depends on the way in which the cell is designed. The generation of gases may be reduced by restricting maximum discharge currents and the swelling may also be inhibited by using particularly strong materials or by using additives that reduce the ageing of the cell. Similar effect may also be achieved by suitable design of the portable device. For instance, a camera phone with a flash light may be designed to temporarily stop radio transmissions and navigation circuitry while using the flash light so as to cut current draw from the battery.

Additionally, or alternatively, the battery cell may be provided with a vent apparatus similarly to vent 120 shown on FIG. 1 configured to release battery gas while preventing entry of water or humid air into the battery cell according to an embodiment of the invention.

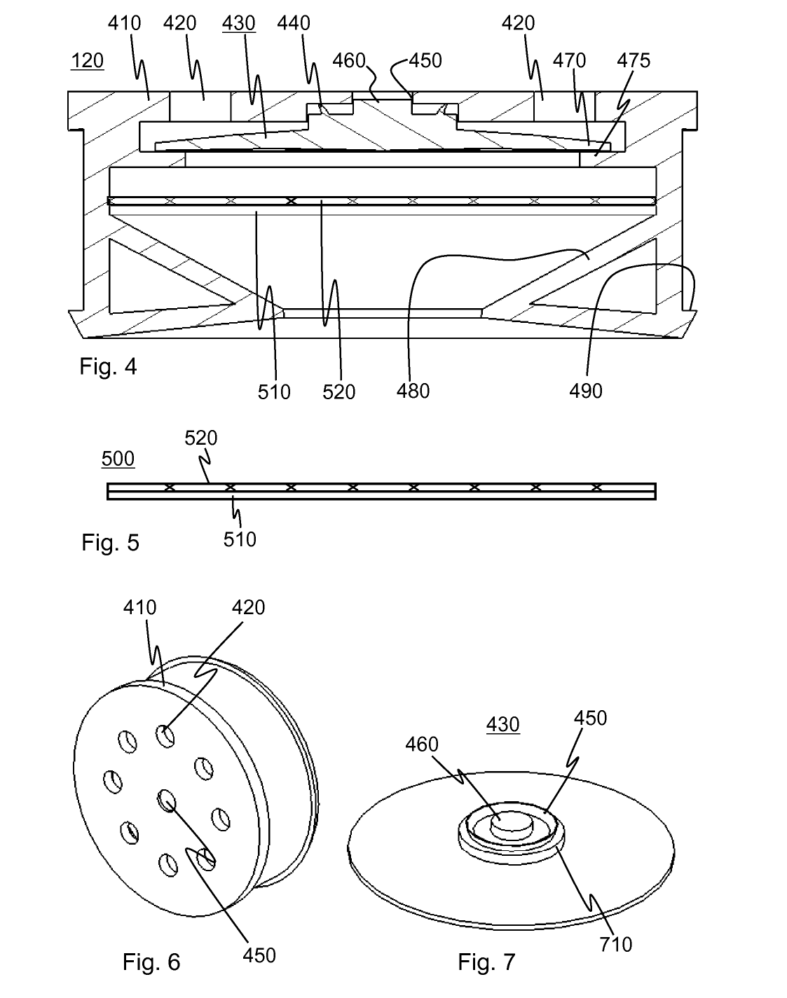

FIG. 3 shows a schematic drawing of the battery cell of FIG. 1, seen from the top. FIG. 3 shows a line A-A through which the vent 120 is shown with more detail in FIG. 4.

FIG. 4 shows a cross-section of an example vent 120 for a battery cell according to an embodiment of the invention. The vent 120 comprises a body 410, a plurality of venting apertures 420, a water separation member 430, a biasing member 440, one or more alignment members 460 of the water separation member 430, one or more guides 450 for engaging with respective alignment members, water proofing parts 470, counter parts 475 for the water proofing parts, gas bubble trap member 480 and a casing sealing surface 490.

The body 410 forms generally a cylindrical shape with a substantially covered top for provided mechanical protection for the interior of the vent 120. The covered top comprises the ventilation apertures 420 and the guides 450 for aligning within the body 410 the water separation member 430. The water separation member 430 is located adjacent to the covered top such that the alignment members engage with the guides 450 and maintain the water separation member 430 correctly aligned. The water separation member 430 may be relatively rigid and biased such that the water proofing parts 470 or edges of the water separation member are pressed against the counter parts 475. The water separation member may be formed as a disc (see FIG. 7) such that the water separation member 430 is simple to assemble without need to align the water separation member 430 in a particular angle (as it can be freely rotated by 360 degrees). The water separation member 430 itself may carry the biasing member 440 that may be integrally formed with the water separation element 430. The biasing member 440 may be formed as an annular spring (see FIG. 7 for isometrically drawn example). Alternatively, the water separation member 430 may be made resiliently flexible such that the water separation member bends under pressure and thus releases gas (in Fig. from down to up) and normally rests tightly against the counter parts 475.

The water separation member together with the body 410 forms a water separation element configured to prevent or substantially inhibit entry of water or humid air through the vent towards the battery cell, while allowing pressurized gas to release from the battery cell between the water proofing parts (rim) 470 and the counter parts 475 (annular protrusion in the body 410).

The water separation member 430 may function as a pressure releasable valve member. The operation of the water separation member 430 becomes clearer in light of the following description of the gas separation element. It is yet worth mentioning here that the water separation member may maintain some overpressure such that even when battery gases are passed through, the overpressure may prevent or mitigate entry of humid air in reverse direction to the exit flow of battery gases.

A gas separation element is provided in order to allow battery gases reach the water separation element while blocking access of the electrolyte to the water separation element. The gas separation element (reference 500 in FIG. 5) in the embodiment shown in FIG. 4 comprises a substrate or support member 510 that carries a gas separation member 520. The substrate may be formed of porous material or of a mesh that is fixed to the body 410. The support member 510 may be provided to provide mechanical support for the gas separation member 520. The gas separation member 520 may comprise a selectively permeable membrane that is configured to allow pass-through of battery gases while blocking the electrolyte. The selectively permeable membrane may comprise any of the following: porous plastics, porous metals, porous, glasses, porous ceramics, porous semiconductors, and any combination thereof.

The support member 510 may comprise a porous base layer. The porous base layer may comprise pores of diameter suited to allow release of gases while withholding electrolyte liquid.

The porous base layer may be coated with a further material so as to control pore size distribution in the gas separation member 520 (that in this case is formed on top of the support member 510 by coating). The coating may comprise one or more selectively permeable materials. The selectively permeable materials may comprise any of: Pt, Pd, alloys or Pd, Pd/Ag alloy, Pd/Cu alloy, Ti/Ni alloy, ZrMn₂, LaNi₅, La, Ti, Zr, V, Nb, Ta, Cr, Mo, W, Fe, Ru, and Co.

The gas bubble trap member 480 may be formed as drawn in FIG. 4 in shape of a triangular protrusion from the cylindrical walls towards the interior of the body 410 such that a narrow tipped gap is left between the gas bubble trap member 480 and the gas separation element 500. When the battery cell is rotated and moved in mixed orientations, gas bubbles may accumulate into a gas bubble trap formed by the gas separation element 500 and the gas bubble trap member 480 such that formed battery gases may be collected and fill the space between the gas separation element 500 and the water separation member 430. It is appreciated that normally gases travel upwards within the battery cell 100. The trap may enable collecting and combining a number of small gas bubbles whenever such bubbles engage with the trap member 480. Hence, when the battery is used in largely varying orientations e.g. when pocketed or carried in a bag, gases can be collected whenever the battery is substantially upright or even sideways. The collecting of the gases at the gas separation element 500 also provides time for the gases to penetrate through the gas separation element and thus fill the space between the gas separation element and the water separation element. When that space is filled with gases, at least a portion of the gases may be released if pressure raises above a predefined threshold level even when the battery cell is in a position where the battery vent is facing down.

In FIG. 4, it may be perceived that the space within the cylindrical body 410 that resides under the gas separation element 500 (510, 520) is a first chamber and the space between the gas separation element 500 and the water separation member 430 is a second chamber. The first chamber may function as an antechamber for collecting battery gas and enabling gas penetrate through a selectively permeable membrane. Thus, the second chamber may be filled with battery gas while battery gas pressure builds up and then be released through the water separation element (430,475) and out through the venting apertures 420 when the pressure is high enough to open an access between the water proofing parts 470 and counter parts 475.

FIG. 4 also shows casing sealing surfaces 490 at which the vent 120 may be sealed to the casing of the battery cell. By arranging the sealing surfaces, as in FIG. 4, substantially outwards from the battery cell, it may be possible to enhance the sealing by the pressure that generates within the battery cell. Also by forming tapered corners as shown in FIG. 4 it may be possible to install the vent 120 by simply tapping the vent into matching aperture in the casing 110 of the battery cell 100.

The gas separation member 520 may be electrically adjustable. For instance, the support member or a further compression member may be configured to tighten pores in the gas separation member 520. The tightening may be carried out by using piezoelectric force, for instance. The adjusting of the gas separation member 520 may be controlled by a controller (e.g. microprocessor, digital signal processor, chip, application specific integrated circuit). The controller may be contained by the battery cell 100 e.g. as an accessory 130 or at a host device (e.g. mobile phone) and connected through connectors of the battery cell.

The gas separation element 500 may be configured to adapt the gas permeability as a function of pressure such that on higher pressure the gas permeability increases. This may be provided, for instance, by forming the gas separation element to stretch under pressure so as to increase the gas permeability.

It is appreciated that the casing 110 of the battery cell may be gas-tight so as to prevent entry of water as vapor into the cell 100. A gas-tight casing (for hydrogen and carbon dioxide, for instance) the casing 110 is also inherently water-tight. On the other hand, the gas separation member may allow exit of any excess water vapor and thereby reduce required dryness of the air on manufacturing and thus also reduce manufacturing costs.

FIG. 6 shows an isometric drawing of an example body 410 vent of FIG. 4 according to an embodiment of the invention. FIG. 6 shows that the vent may generally have cylindrical shape with a neck that helps attaching the body 410 to the casing 110. FIG. 6 also shows how a number of venting apertures may be arranged in the body 410 such that release of gas in sufficient amounts is possible while reasonable mechanical protection is provided to the water separation member 430.

The venting apertures may be circular. The diameter and number of the venting apertures may be selected such that on one hand, the venting apertures enable release of battery gases without undue dynamic pressure while entry of dirt or larger impurity particles is inhibited. Alternatively, or additionally, a mesh or gas permeable membrane may be placed in the venting apertures, on top of the venting apertures or under the venting apertures.

FIG. 7 shows an isometric drawing of a detail of the vent of FIG. 4 according to an embodiment of the invention. FIG. 7 illustrates an example of the water separation member 430 that is made of plastics, rubber, metal and/or composite material. FIG. 7 shows that the alignment member 460 may be a cylindrically protruding member and that the alignment member may comprise another alignment part 710 to engage with another guide surface supported by the body 410. The alignment member 460 may alternatively be formed as a receptacle configured to receive a protruding part in the body 410. Moreover, instead of an annular alignment member, the water separation member may comprise two or more discreet alignment parts configured in a desired constellation.

FIG. 8 shows a schematic drawing of a battery 800 comprising a battery cell 100 according to an embodiment of the invention. The battery 800 further comprises a connector element 820 that defines an opening 840 aligned with the vent 120 of the battery cell 100. The battery 800 further comprises a set of connectors 830 for connecting with contacts of a host device; a connector end 850 configured to encapsulate the connector part against one end of the cell 100; and a rear end 810 configured to cover the opposite end of the cell 100.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. An apparatus comprising:
a body with a circumferential wall defining an external surface and a space within the body, the external surface comprising a sealing surface configured for hermetic sealing to a wall of a battery cell;
a gas separation element configured to pass through gases from the battery cell and to substantially inhibit electrolyte of the battery cell from passing through, configured to divide a given portion of the space into a first chamber and a second chamber; and
a water separation element within the second chamber and further defining the second chamber, configured to substantially prevent entry of water as liquid or humid air through the second chamber to the gas separation element.

18. An apparatus according to claim 17, wherein the gas separation element comprises a selectively permeable membrane.

19. An apparatus according to claim 18, wherein the selectively permeable membrane comprises any of the following: porous plastics, porous metals, porous glasses, porous ceramics, porous semiconductors, and any combination thereof.

20. An apparatus according to claim 18, wherein the selectively permeable membrane is configured to allow release of gases while withholding electrolyte liquid.

21. An apparatus according to claim 17, wherein the gas separation element further comprises a gas bubble trap configured to trap gas bubbles in different orientations of the apparatus.

22. An apparatus according to claim 21, wherein the gas bubble trap comprises a set of obliquely aligned trap members.

23. An apparatus according to claim 17, wherein the water separation element comprises a pressure releasable valve member configured to release gases from the second chamber when pressure in the second chamber reaches a predetermined pressure limit.

24. An apparatus according to claim 18, wherein the water separation element comprises a pressure releasable valve member configured to release gases from the second chamber when pressure in the second chamber reaches a predetermined pressure limit.

25. An apparatus according to claim 17, wherein the apparatus further comprises a processor and a connector configured to functionally connect the processor to the battery cell; wherein the processor is configured to monitor operation of the battery cell.

26. An apparatus according to claim 25, wherein the gas separation element is configured to electrically change permeability properties thereof under control of the processor.

27. An apparatus according to claim 17, wherein the sealing surface is configured such that increasing pressure within the battery cell presses the sealing surface against the wall of the battery cell.

28. An apparatus according to claim 18, wherein the sealing surface is configured such that increasing pressure within the battery cell presses the sealing surface against the wall of the battery cell.

29. An apparatus according to claim 17, wherein the cell is exothermically reactive with water.

30. An apparatus of claim 17, further comprising:
a battery cell;
a casing around the battery cell, wherein the casing is gas-tight; and
a vent arranged in the casing and configured to allow exit of gases from the battery cell, wherein the vent comprises the body, the casing and the water separation element.

31. An apparatus of claim 18, further comprising:
a battery cell;
a casing around the battery cell, wherein the casing is gas-tight; and
a vent arranged in the casing and configured to allow exit of gases from the battery cell, wherein the vent comprises the body, the casing and the water separation element.

32. A method comprising:
passing gases from a first chamber within a battery cell through a gas separation element to a second chamber while preventing electrolyte of the battery cell from passing through the gas separation element; and
allowing the gases exit the second chamber through a water separation element while preventing entry of water as liquid or humid air into the second chamber.

33. A method comprising:
mounting an apparatus to a casing of a battery cell; and
sealing hermetically the external surface to the casing; wherein the apparatus comprises:
a body with a circumferential wall defining an external surface and a space within the body, the external surface comprising a sealing surface configured for hermetic sealing to a wall of a battery cell;
a gas separation element configured to pass through gases from the battery cell and to substantially inhibit electrolyte of the battery cell from passing through, configured to divide a given portion of the space into a first chamber and a second chamber; and
a water separation element within the second chamber and further defining the second chamber, configured to substantially prevent entry of water as liquid or humid air through the second chamber to the gas separation element.

34. A method according to claim 33, further comprising allowing the gases exit from the second chamber through the water separation element when pressure in the second chamber reaches a predetermined pressure limit.

35. An apparatus comprising:
body means with a circumferential wall for defining an external surface and a space within the body, the external surface comprising a sealing surface for hermetic sealing to a wall of a battery cell;
gas separation means configured to pass through gases from the battery cell and to substantially inhibit electrolyte of the battery cell from passing through, configured to divide a given portion of the space into a first chamber and a second chamber; and
a water separation means within the second chamber and further defining the second chamber, configured to substantially prevent entry of water as liquid or humid air through the second chamber to the gas separation means.
